(19) United States
(12) Patent Application Publication
(10) Pub. No.: US 2024/0095798 A1
(43) Pub. Date: Mar. 21, 2024

(54) PRODUCT DESIGN GENERATION SUPPORT DEVICE, PRODUCT DESIGN GENERATION SUPPORT METHOD AND COMPUTER READABLE MEDIUM

(71) Applicant: NEC Corporation, Minato-ku, Tokyo (JP)

(72) Inventors: Ryo TOMARU, Tokyo (JP); Makoto Takamoto, Tokyo (JP)

(73) Assignee: NEC Corporation, Minato-ku, Tokyo (JP)

(21) Appl. No.: 18/274,657

(22) PCT Filed: Mar. 31, 2021
(86) PCT No.: PCT/JP2021/013818

§ 371 Date: Jul. 27, 2023

(51) Int. Cl. G06Q 30/0601

(52) U.S. Cl. CPC G06Q 30/0621

(57) ABSTRACT

The acquisition unit acquires a design image relating to the design of the target product. The estimation unit uses the design image and an estimation model and estimates opinion information and line-of-sight information of a target person regarding the design of the target product. The estimation model is a model obtained by switching persons and products in various ways to learn the relation between, on the one hand, training product information, including product design images, and training attribute information about persons, and, on the other hand, training line-of-sight information of the persons regarding the product designs and training opinion information of the persons regarding the product designs. The output unit outputs the line-of-sight information and the opinion information estimated by the estimation unit.

### TECHNICAL FIELD

The present invention relates to a technology for providing information on how people feel about a design of a product.

### BACKGROUND ART

At the time of determining the design of a new product or a renewal product, the design of the product may be determined from among a plurality of candidates for the design with reference to a result of a central location test (CLT). The central location test is a test method in which test subjects (monitors) gather at a preset site to conduct a questionnaire (including an interview). For example, in the central location test with respect to the design of the product, the monitors who have looked at the candidate for the design of the product are asked about their purchase intentions as to whether they want to purchase the product. In addition, the monitors are requested to give comments on the candidate for the design of the product.

Note that PTL 1 (WO 2021/009880 A1) discloses a technology for estimating a user's impression of a product when the product is designed by combining design elements related to a plurality of portions (parts) constituting the product such as shoes and clothes.

Furthermore, PTL 2 (WO 2020/144820 A1) discloses a technology for estimating a result of a user's evaluation with respect to a product by focusing on an attribute of the product.

### CITATION LIST

### Patent Literature

PTL 1: WO 2021/009880 A1
PTL 2: WO 2020/144820 A1

### SUMMARY OF INVENTION

### Technical Problem

Since information on purchase intentions and comments of monitors (in other words, consumers) who have looked at a candidate for a design of a product can be obtained through a central location test with respect to the design of the product, the result of the central location test is effective information at the time of creating or determining a design of a product.

However, a large number of monitors are required to conduct a central location test, and it takes time and effort to set the central location test, select the monitors, and analyze the central location test.

A main object of the present invention is to provide a technology capable of suitably supporting creation (generation) of a product design.

### Solution to Problem

According to an aspect of the present invention for achieving the foregoing object, a product design generation support device includes:
an acquisition unit that acquires a design image related to a design of a target product;
an estimation unit that estimates line-of-sight information and opinion information of a target person with respect to the design of the target product using the design image and an estimation model; and
an output unit that outputs the line-of-sight information and the opinion information,
in which the estimation model is a model obtained by learning relations of product information for learning including a design image of a product and attribute information for learning of the person with line-of-sight information for learning of the person with respect to the design of the product and opinion information for learning of the person with respect to the design of the product.

According to another aspect of the present invention, a product design generation support method performed by a computer includes:
acquiring a design image related to a design of a target product;
estimating line-of-sight information and opinion information of a target person with respect to the design of the target product using the design image and an estimation model; and
outputting the line-of-sight information and the opinion information,
in which the estimation model is a model obtained by learning relations of product information for learning including the design image of the product and attribute information for learning of the person with line-of-sight information for learning of the person with respect to the design of the product and opinion information for learning of the person with respect to the design of the product.

According to another aspect of the present invention, a program storage medium storing a computer program that causes a computer to execute:
acquiring a design image related to a design of a target product;
estimating line-of-sight information and opinion information of a target person with respect to the design of the target product using the design image and an estimation model; and
outputting the line-of-sight information and the opinion information,
in which the estimation model is a model obtained by learning relations of product information for learning including the design image of the product and attribute information for learning of the person with line-of-sight information for learning of the person with respect to the design of the product and opinion information for learning of the person with respect to the design of the product.

### Advantageous Effects of Invention

According to the present invention, it is possible to suitably support creation (generation) of a product design.

### BRIEF DESCRIPTION OF DRAWINGS

FIG. 1 is a diagram illustrating a configuration of a product design generation support device according to a first example embodiment.

FIG. 2 is a diagram illustrating an example of a central location test.

FIG. 3 is a diagram illustrating an example of a graph (knowledge graph) used for generating an estimation model.

FIG. 4 is a diagram illustrating an example of the estimation model.

FIG. 5 is a diagram illustrating another example of the estimation model.

FIG. 6 is a diagram illustrating another example of an input to the estimation model.

FIG. 7 is a diagram illustrating an example in which line-of-sight information and opinion information are displayed.

FIG. 8 is a flowchart illustrating an example of an operation of the product design generation support device according to the first example embodiment.

FIG. 9 is a diagram illustrating an example of an estimation model used in a second example embodiment.

FIG. 10 is a diagram illustrating another example of the estimation model used in the second example embodiment.

FIG. 11 is a diagram illustrating an example of a graph (knowledge graph) used for generating an estimation model in the second example embodiment.

FIG. 12 is a diagram illustrating an example in which line-of-sight information and opinion information are displayed.

FIG. 13 is a diagram illustrating an example in which line-of-sight information, opinion information, and a reason for estimation are displayed.

FIG. 14 is a diagram illustrating a state in which products are displayed on a shelf.

FIG. 15 is a diagram illustrating an example of a display showing ranks of designs.

FIG. 16 is a diagram illustrating another example of the estimation model.

FIG. 17 is a diagram illustrating a configuration of a product design generation support device according to another example embodiment.

FIG. 18 is a flowchart illustrating an example of an operation of the product design generation support device according to another example embodiment.

### EXAMPLE EMBODIMENT

Hereinafter, example embodiments according to the present invention will be described with reference to the drawings.

### First Example Embodiment

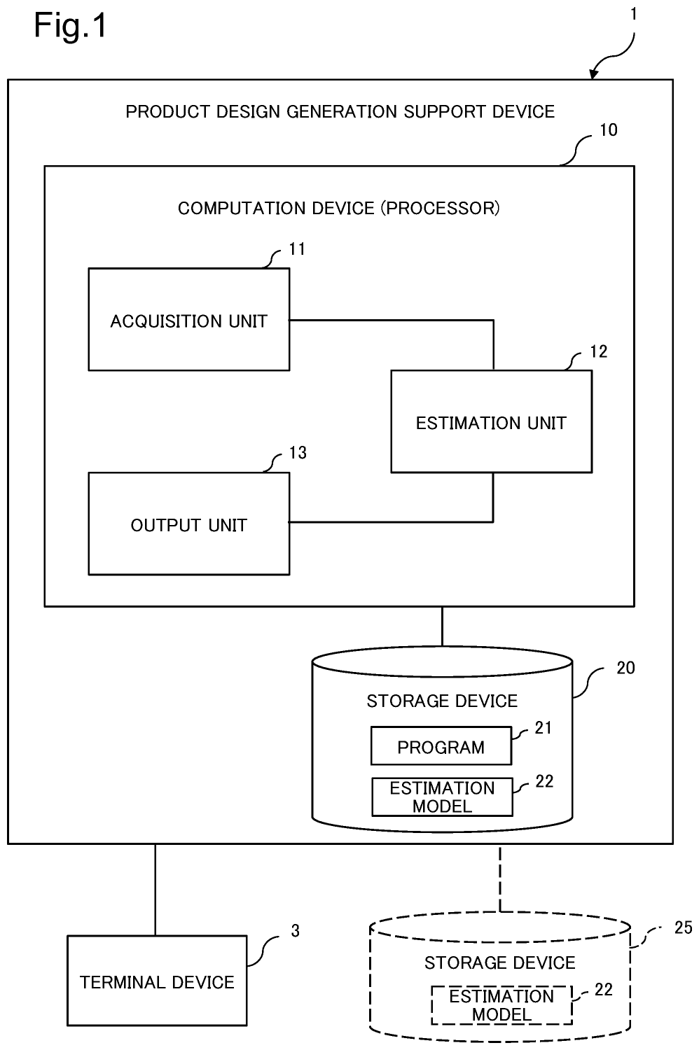

FIG. 1 is a diagram illustrating a configuration of a product design generation support device according to a first example embodiment of the present invention. The product design generation support device 1 according to the first example embodiment has a function of, when a design image of a product is input, estimating line-of-sight information and opinion information of a target person for the design of the product, and outputting the estimated line-of-sight information and opinion information. In the following description, the product design generation support device will also be referred to as support device in short.

Products include not only products having shapes such as foods, toys, miscellaneous goods, furniture, home appliances, and clothes, but also intangible products such as services and information, and the products herein refer to tangible products. A design includes to a shape, a pattern, a color, or a combination thereof of a product. A design of a product includes a design of a product itself, a design of a product package, or a combination thereof. In addition, some products have a form in which contents such as foods, toys, and miscellaneous goods are accommodated in packages. In a case where a product includes such a package, the design of the product targeted by the support device 1 may be a design of only one of the package and the content thereof, or may be a design of each of or a combination of the package and the content. Although the support device 1 can cope with any of the foregoing designs, the configuration of the support device 1 will be described using a design of a product package (hereinafter also referred to as package design) as an example in the first example embodiment.

A design image of a product input to the support device 1 is an image showing a design of a product, such as a captured image obtained by imaging a product or an illustration image in which a product is drawn.

The line-of-sight information is information regarding a line of sight of a target person with respect to a design of a product. The target person here refers to a person who has looked at a product, and as an example, is a target person (hereinafter also referred to as a monitor) of a central location test. Note that the target person is not limited to a target person (monitor) of a central location test, but in the following description, it is assumed that the target person is a target person (monitor) of a central location test.

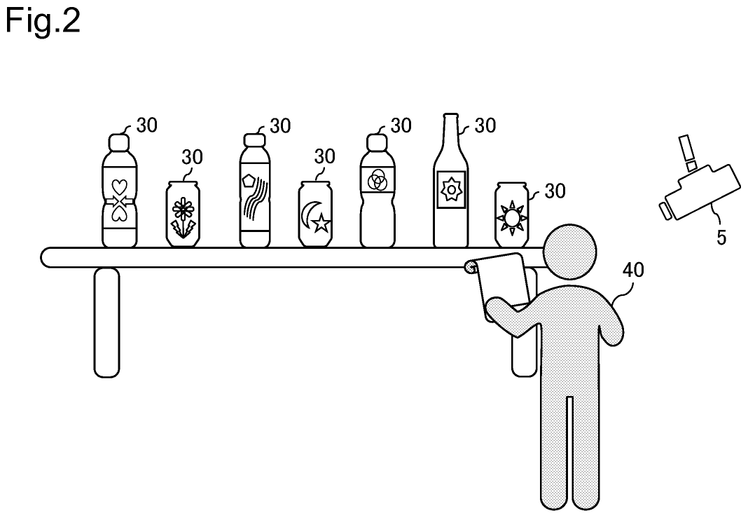

Examples of the line-of-sight information include a viewing time, the number of viewing times, a viewing rate, and the like, but are not limited thereto as long as the line-of-sight information is information regarding a line of sight. For example, at a site (test site) for a central location test, a plurality of products including a product to be tested are arranged as illustrated in FIG. 2. FIG. 2 is a diagram illustrating an example of a state of a test site where a central location test on a package design of a beverage is conducted. In the example of FIG. 2, a plurality of products 30 having different package designs are arranged, and some or all of the products 30 are products to be tested. The product to be tested is a product for which it is desired to test what opinion a monitor 40 has, and here, is a product having a package design candidate that may be adopted as a product package. Here, the product to be tested is also referred to as target product. In addition, in a case where products other than the product to be tested are arranged, the products other than the product to be tested are used for comparison with the product to be tested. A plurality of packages in FIG. 2 have different shapes, patterns (including pictures, lettering details (fonts and sizes of characters used in design), and arrangement positions thereof), colors, materials (e.g., PET bottles, cans, and jars), and the like, but one of them may be common between the plurality of packages. In addition, here, prototypes that are not actually sold as products and comparative products are also collectively referred to as products.

The viewing time is a time for which the monitor 40 has looked at a certain target product. The number of viewing times is the number of times a monitor 40 has looked at a certain target product in a situation where a plurality of products 30 are arranged.

The viewing rate is a ratio of a time for which the monitor 40 has looked at a certain target product to a time for which the monitor 40 has looked at the plurality of products 30 arranged, or a ratio of the number of times the monitor 40 has looked at a certain target product to the total number of times the monitor 40 has looked at the plurality of products 30.

The line-of-sight information output from the support device 1 is information regarding a line of sight including at least one of the viewing time, the number of viewing times, and the viewing rate as described above.

The opinion information is information indicating an opinion of a monitor 40 on a design of a target product obtained by, for example, a questionnaire regarding the design of the product. In the first example embodiment, the opinion of the monitor 40 on the design (package) of the target product is an opinion indicating whether or not the monitor 40 has wanted to purchase the target product after looking at the target product (also referred to as purchase intention in the following description).

The product design generation support device 1 according to the first example embodiment is a computer (e.g., a server or the like disposed in a data center), and can be connected to a terminal device 3, for example, via a wired or wireless information communication network as illustrated in FIG. 1. The terminal device 3 is a personal computer (PC), a tablet, a smartphone, a wearable terminal, or the like. For example, a design image of a target product is transmitted from the terminal device 3 to the support device 1.

The support device 1 includes a computation device 10 and a storage device 20. The storage device 20 has a configuration for storing various data and a computer program (hereinafter also referred to as program) 21 for controlling the operation of the support device 1, and includes, for example, a storage medium such as a hard disk device or a semiconductor memory. The number of storage devices included in the support device 1 is not limited to one, and a plurality of types of storage devices may be included in the support device 1, and in this case, the plurality of storage devices are collectively referred to as storage device 20.

In the first example embodiment, the storage device 20 also stores an estimation model 22. The estimation model 22 is a model to which a design image of a target product is input and from which line-of-sight information and opinion information of a target person with respect to the design of the target product are output, and is generated by machine learning, for example, deep learning. In the learning for generating the estimation model 22, the first product and the first person are changed in various ways while learning relations of product information for learning including a design image indicating a design of a first product and attribute information for learning of a first person who has looked at the design of the first product with opinion information for learning indicating a purchase intention of the first person who has looked at the design of the first product and line-of-sight information for learning of the first person who has looked at the design of the first product.

The first product refers to each of the products 30 including prototypes and comparative products arranged as illustrated in FIG. 2, for example, in a test on a design of a product performed before the estimation model 22 is generated.

The product information includes, for example, a product name, a flavor type, a content amount, a price, a place of origin, a raw material, a place where a material is produced, an additive, a nutrient component, functionality, etc., in addition to the design image. In addition, for example, in a case where the product is an alcoholic beverage, the product information includes an alcohol content (alcohol percentage) in addition to the above-described product information. The product information other than the design image used for generating the estimation model 22 is appropriately selected in consideration of a product type and the like.

The first person is a monitor, for example, in a test for a design of a product performed before the estimation model 22 is generated. In particular, various types of information regarding the first person are used to generate the estimation model 22.

Examples of the attribute information of the person include age, lifestyle information (e.g., information about meals such as the number of meals per day and meal times, an exercise amount per week, sleeping hours, a wake-up time, a bedtime, and a commuting time), preference information, and hobby. The attribute information for learning of the person to be used for generating the estimation model 22 is appropriately selected in consideration of a product type and the like. In addition, the attribute information for learning of the person to be used for generating the estimation model 22 can be acquired through a questionnaire at a test site or the like. Furthermore, in a case where the monitor 40 is, for example, a person selected from among persons who have registered the above-described attribute information in advance, the attribute information for learning of the person can be acquired from the registered information.

The purchase intention information of the person, which is opinion information for learning, and the line-of-sight information for learning of the person learned for generating the estimation model 22 are information obtained before the estimation model 22 is generated. For example, at the test site, the purchase intention information of the person (monitor 40) who has looked at the products 30 arranged as illustrated in FIG. 2 can be acquired through a questionnaire. Furthermore, the line-of-sight information of the person (monitor 40) can be acquired as follows. For example, at the test site, the line-of-sight information of the monitor 40 can be obtained by photographing at least a face of the monitor 40 looking at the products 30 arranged as illustrated in FIG. 2 using an imaging device 5, and analyzing a captured image (captured moving image) obtained thereby. That is, from the analysis of the captured image, a viewing time, the number of viewing times, and a viewing rate with respect to the target product for the person (monitor 40) looking at the design of the target product can be acquired. In addition, by analyzing the captured image, it is possible to acquire, as the line-of-sight information, information on a trajectory of a line of sight along which a plurality of products 30 arranged are looked at, a trajectory of a line of sight with respect to one product 30 when the one product 30 is looked at, and a portion of interest.

Note that, at the time of generating the estimation model 22, it is necessary to associate monitors 40 appearing in the captured image with monitors 40 answering the questionnaire. In other words, for the same person, it is necessary to associate line-of-sight information, opinion information (purchase intention), and attribute information of the person. Among various methods for associating such information, any method may be adopted here, and the description thereof will be omitted.

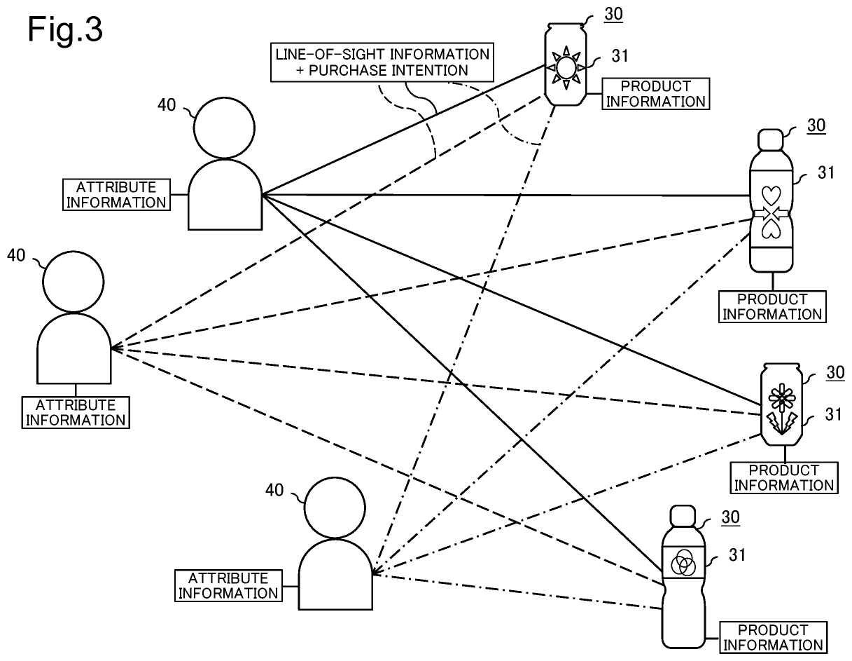

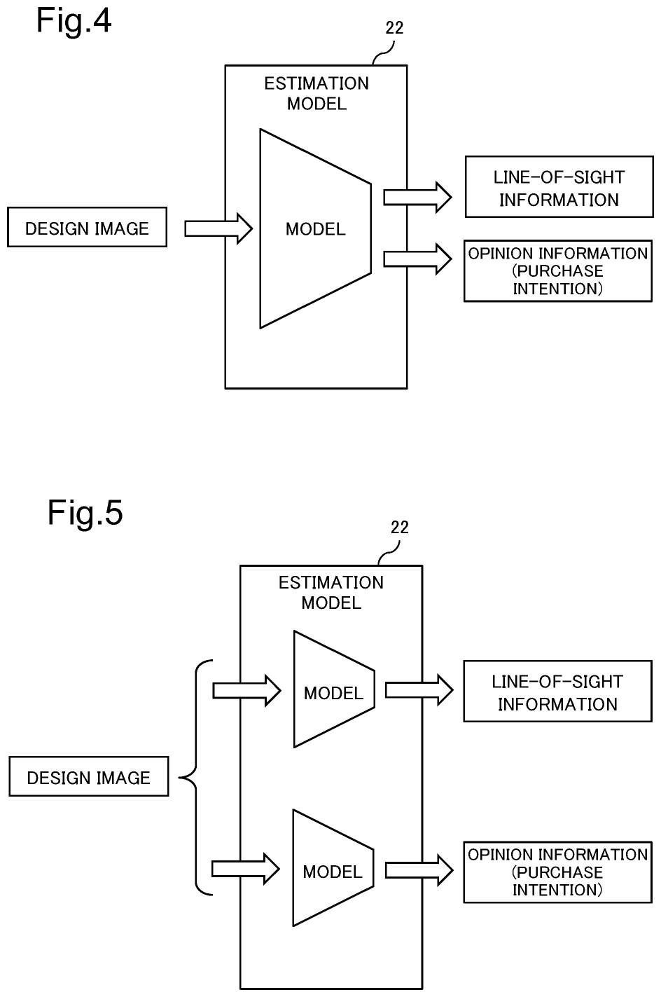

In the first example embodiment, the estimation model 22 is generated by machine learning using graph-based learning of relationship. For example, a graph (also referred to as knowledge graph) in which persons (monitors) 40 and products 30 (packages 31) are set as nodes and line-of-sight information for learning and opinion information (purchase intention) for learning are set as edges as illustrated in FIG. 3 is generated based on the information acquired by the central location test. Then, the nodes and the edges of the graph are vectorized using a graph artificial intelligence (AI) technology. That is, the nodes and the edges in the graph are converted into vector representations (embedding vectors). The estimation model 22 is generated by deep learning using feature vectors of the nodes obtained by doing so. The estimation model 22 may include a model that outputs line-of-sight information and opinion information (purchase intention) when a design image is input thereto as illustrated in FIG. 4, or may include two types of models that output line-of-sight information and opinion information (purchase intention), respectively, when a design image is input thereto as illustrated in FIG. 5.

Note that the support device 1 may be connected to an external storage device 25 as indicated by a dotted line in FIG. 1, and the estimation model 22 may be stored in the storage device 25 instead of the storage device 20 built in the support device 1. In this case, the support device 1 can use the estimation model 22 by communicating with the storage device 25 in a wired or wireless manner.

The computation device 10 of the support device 1 illustrated in FIG. 1 includes a processor such as a central processing unit (CPU) or a graphics processing unit (GPU). The computation device 10 can have various functions when the processor executes the program 21 stored in the storage device 20. In the first example embodiment, the computation device 10 includes an acquisition unit 11, an estimation unit 12, and an output unit 13 as functional units.

That is, the acquisition unit 11 acquires a design image of a target product output from the terminal device 3. The acquired design image is, for example, an image showing one candidate for a new package design of a new product or a renewal product.

Using the design image acquired by the acquisition unit 11 and the estimation model 22 of the storage device 20, the estimation unit 12 estimates line-of-sight information and opinion information (purchase intention) of a target person with respect to the design of the target product. In other words, the estimation unit 12 estimates line-of-sight information and opinion information of a monitor 40 with respect to the design of the target product shown in the design image acquired by the acquisition unit 11, which are estimated to be obtained, for example, in a case where a central location test is conducted with respect to a target product having a package design.

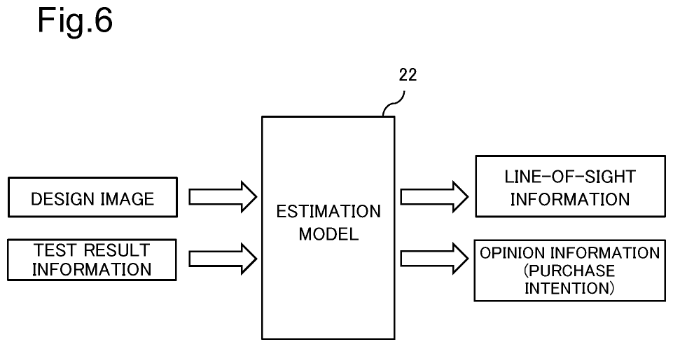

Note that the estimation unit 12 may be configured to input not only the design image but also information on feature vectors of nodes obtained from the graph illustrated in FIG. 3 (that is, test result information) based on a result of a central location test that has been completed to the estimation model 22 as illustrated in FIG. 6. This configuration makes it possible to increase the reliability of the estimation of the line-of-sight information and the opinion information.

The output unit 13 outputs the line-of-sight information (hereinafter also referred to as estimated line-of-sight information) and the opinion information (hereinafter also referred to as estimated opinion information) estimated by the estimation unit 12.

The estimated line-of-sight information estimated by the estimation unit 12 and output by the output unit 13 includes, for example, information on an estimated viewing time, such as information indicating that a viewing time for which the monitor looks at the target product is estimated to be 12 seconds on average. In addition, the estimated line-of-sight information may include, for example, information on an estimated number of viewing times, such as information indicating that the number of viewing times the monitor looks at the target product is estimated to be three on average. Furthermore, the estimated line-of-sight information may include, for example, information on an estimated viewing rate, such as information indicating that the viewing rate is estimated to be 28% on average. Furthermore, the estimated line-of-sight information may include information indicating a preset number of upper-ranked groups in descending order of estimated viewing times for which target products are looked at, and an estimated viewing time for each group. As a specific example, the estimated line-of-sight information may include information indicating that a group having the longest estimated viewing time is a group of people who likes fruits and the estimated viewing time is 20 seconds, a group having the second longest estimated viewing time is a group of people who are in the early twenties and the estimated viewing time is about 18 seconds. With respect to the estimated number of viewing times and the estimated viewing rate, the estimated line-of-sight information may include, for example, information indicating a preset number of upper-ranked groups in descending order of numerical values, in addition to the estimated number of viewing times and the estimated viewing rate, as described above. Note that the group as described above is generated, for example, by the estimation model 22 based on the attribute information and the line-of-sight information of the person (monitor 40).

Further, two or all of the estimated viewing time, the estimated number of viewing times, and the estimated viewing rate may be included in the estimated line-of-sight information. Furthermore, reference information may be included in the estimated line-of-sight information together with at least one of the estimated viewing time, the estimated number of viewing times, and the estimated viewing rate. The reference information is information to be referred to when a design creator or the like evaluates (analyzes) the design of the target product based on the estimated line-of-sight information. The reference information is not particularly limited, but as an example thereof, it is may be considered that information indicating an average viewing time, an average number of viewing times, and an average viewing rate for one product 30 is shown together with information on an average number of samples for each of the products 30 arranged at the test site.

The estimated opinion information estimated by the estimation unit 12 and output by the output unit 13 is, for example, information on an estimated purchase intention, such as information indicating that it is estimated that, among monitors 40 who have looked at a design of a target product, 25% of the people will not purchase the target product, because 35% of the people has answered that they want to purchase the target product and 40% of the people has answered that they neither have an intention to purchase the target product nor have an intention not to purchase the target product. Furthermore, the estimated opinion information may be information indicating that it is estimated that 43% of a group of people who like fruits has an intention to purchase the target product and 10% of a group of people who like an alcoholic beverage having an alcohol degree of 7% or more has an intention to purchase the target product. As described above, various aspects are assumed in the estimated opinion information, and the aspect is not limited as long as the estimated opinion information includes purchase intention information after looking at a design of a target product.

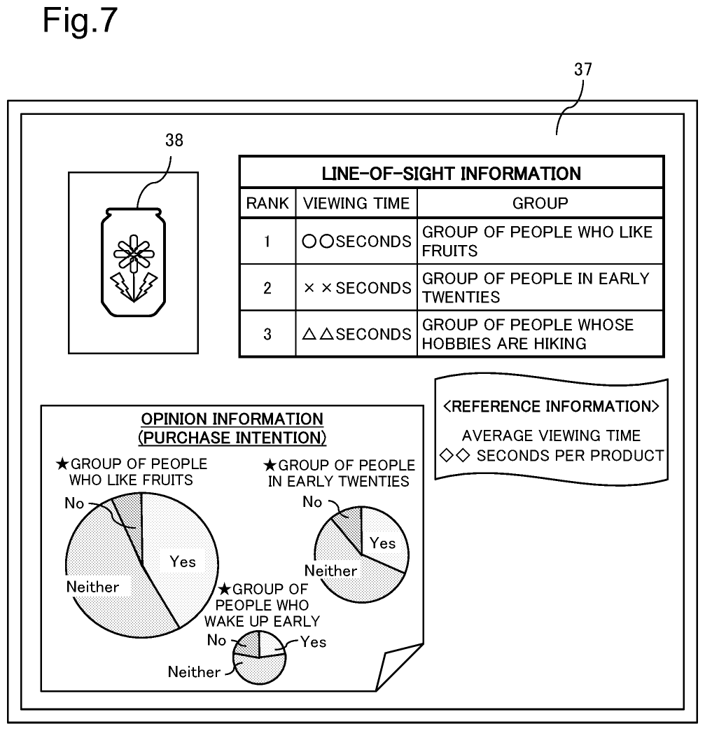

The estimated line-of-sight information and the estimated opinion information output by the output unit 13 as described above are transmitted, for example, to the terminal device 3, and are displayed on the display device according to a display control operation of the terminal device 3. FIG. 7 is a diagram illustrating an example in which estimated line-of-sight information and estimated opinion information are displayed on the display device. In the example of FIG. 7, estimated line-of-sight information, estimated opinion information, and reference information are displayed on a screen 37 of the display device together with a design image 38 of a target product. As the estimated line-of-sight information, information indicating viewing times and groups corresponding to the viewing times is displayed from a first rank to a third rank in descending order of the viewing times. As the estimated opinion information (purchase intention), information on a purchase intention is displayed in a graph for each group. Further, information on an average viewing time for one product 30 is displayed as the reference information.

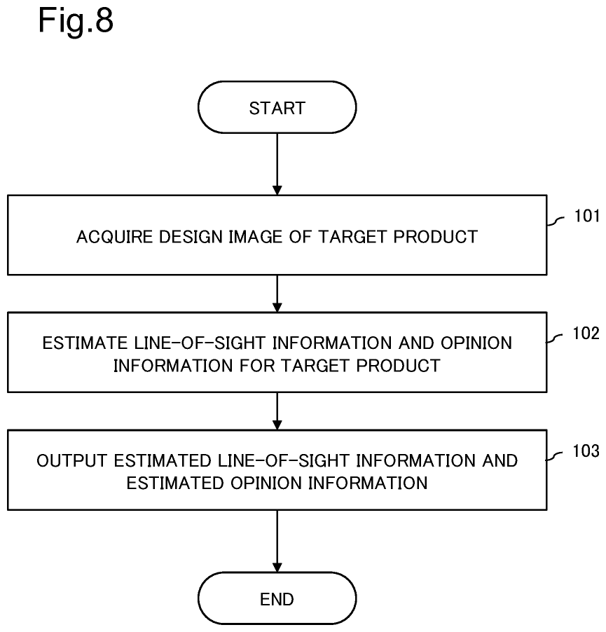

The support device 1 according to the first example embodiment is configured as described above. Hereinafter, an example of an operation of the computation device 10 for estimating line-of-sight information and opinion information will be described with reference to FIG. 8. FIG. 8 is a flowchart illustrating an example of the computation device 10 for estimating line-of-sight information and opinion information.

For example, when a design image of a target product is transmitted from the terminal device 3 to the support device 1, the acquisition unit 11 of the computation device 10 acquires the design image of the target product (step 101). Thereafter, the estimation unit 12 estimates line-of-sight information and opinion information of a target person with respect to the design of the target product using the acquired design image and the estimation model 22 (step 102). Then, the output unit 13 outputs the line-of-sight information (estimated line-of-sight information) and the opinion information (estimated opinion information) estimated by the estimation unit (step 103).

As described above, the support device 1 according to the first example embodiment has a function of, when acquiring a design image of a target product, estimating line-of-sight information and opinion information (purchase intention) of a target person with respect to the design of the target product using the design image and the estimation model 22. Since the estimated line-of-sight information and opinion information are information estimated to be obtained in a case where a test such as a central location test is conducted, the support device 1 is advantageous in that information estimated to be obtained through a test such as a central location test can be provided even though the test such as a central location test is not actually conducted. By using the line-of-sight information and the opinion information provided by the support device 1, it is not necessary to conduct a test such as a central location test, thereby making it possible to efficiently determine a product design (e.g., a package design) and shorten a time from developing a new product to releasing the product. That is, the support device 1 according to the first example embodiment can suitably support creation (generation) of a product design.

In particular, the support device 1 can output the line-of-sight information as described above. Since a design of a product greatly contributes to giving a visual impression of the product, the line-of-sight information is effective information in creating a design of a product.

### Second Example Embodiment

Hereinafter, a second example embodiment of the present invention will be described. In the description of the second example embodiment, the same reference signs will be given to components having the same terms as those of the product design generation support device 1 according to the first example embodiment, and the redundant description of the common components will be omitted.

Similarly to the first example embodiment, when acquiring a design image of a target product, the product design generation support device (support device) 1 according to the second example embodiment estimates and outputs line-of-sight information and opinion information of a target person with respect to the design of the target product. However, in the second example embodiment, as the opinion information, a text expressing a comment on the design of the target product, rather than purchase intention information, is output from the support device 1.

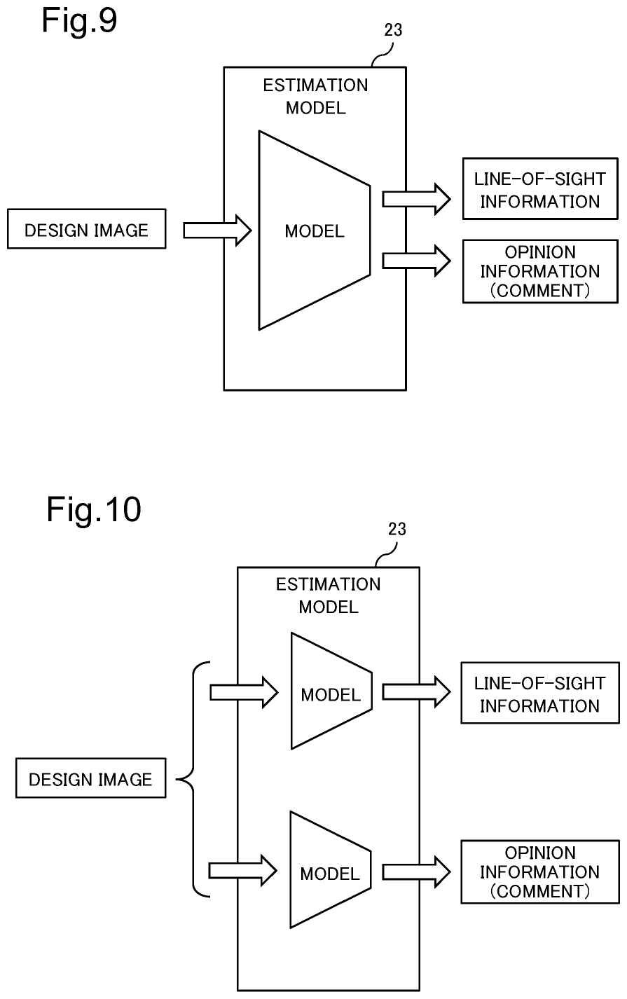

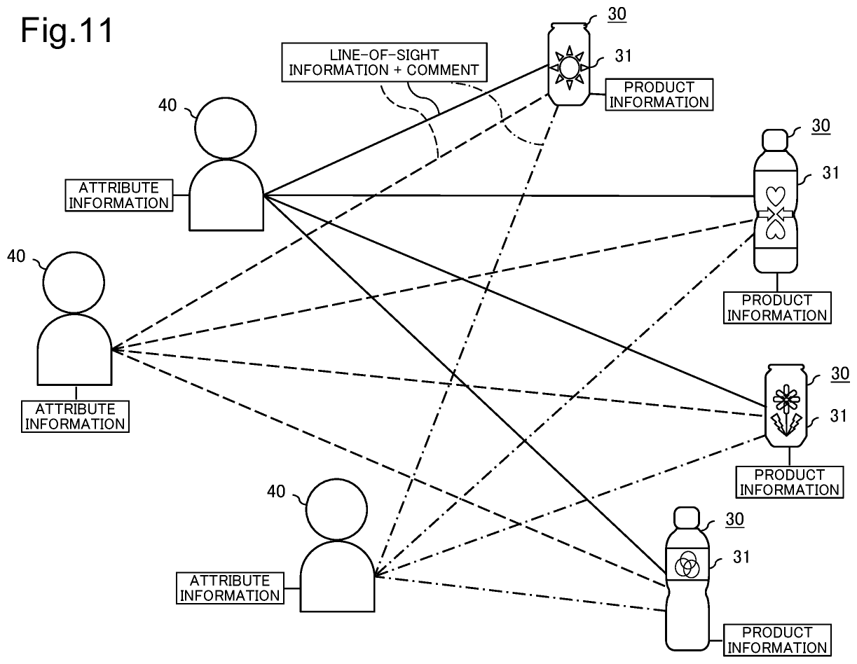

That is, in the second example embodiment, the estimation model 22 described in the first example embodiment is replaced with an estimation model 23 as illustrated in FIG. 9 or 10 is generated by learning and stored in the storage device 20 of the support device 1. That is, for example, a graph in which persons (monitors) 40 and products 30 (packages 31) are set as nodes and line-of-sight information for learning and opinion information (comment) for learning are set as edges as illustrated in FIG. 11 is generated based on the information acquired by the central location test. Then, the nodes and edges of the generated graph are vectorized using a graph AI technology. The estimation model 23 is generated by deep learning using feature vectors of the nodes obtained by doing so. Similarly to the estimation model 22, the estimation model 23 may include a model that outputs line-of-sight information and opinion information (comment) when a design image is input thereto as illustrated in FIG. 9, or may include two types of models that output line-of-sight information and opinion information (comment), respectively, when a design image is input thereto as illustrated in FIG. 10. In the second example embodiment, since the opinion information including a text is information in which a comment is expressed by the text, the estimation model 23 uses, for example, a caption generation technology.

In the second example embodiment, using the design image acquired by the acquisition unit 11 and the estimation model 23 of the storage device 20, the estimation unit 12 estimates line-of-sight information and opinion information (comment) of a target person with respect to the design of the target product. The number of comments as the opinion information estimated by the estimation unit 12 is not limited, and there may be one comment or a plurality of comments. The estimated comment is, for example, text information such as “the picture is cute”, “the taste image matches the picture”, and “it is difficult to understand whether the beverage is an alcoholic or non-alcoholic” regarding the design of the target product. Note that, similarly to the first example embodiment, the estimation unit 12 may be configured to input not only the design image but also information on feature vectors of nodes obtained from the graph illustrated in FIG. 11 (that is, test result information) based on a result of a central location test that has been completed to the estimation model 23.

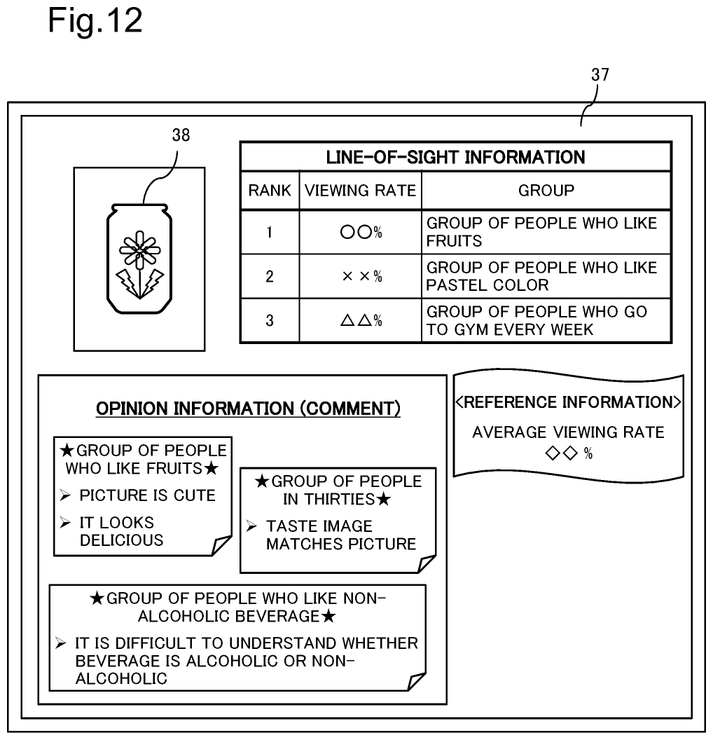

In the second example embodiment, the output unit 13 outputs information on the estimated comment expressed by the text as described above as the estimated opinion information. That is, the output unit 13 outputs the line-of-sight information estimated by the estimation unit 12 and the information on the estimated comment, which is estimated opinion information. Similarly to the first example embodiment, the estimated line-of-sight information and the estimated opinion information output by the output unit 13 are transmitted, for example, to the terminal device 3, and are displayed on the display device according to a display control operation of the terminal device 3. FIG. 12 is a diagram illustrating an example in which estimated line-of-sight information and estimated opinion information are displayed on the display device. In the example of FIG. 12, estimated line-of-sight information, estimated opinion information, and reference information are displayed on a screen 37 of the display device together with a design image 38 of a target product. As the estimated line-of-sight information, information indicating viewing rates and groups corresponding to the viewing rates is displayed from a first rank to a third rank in descending order of the viewing rates. As the estimated opinion information (estimated comment), a comment is displayed as a text for each group. Further, information on an average viewing rate for one product 30 is displayed as the reference information.

The other configurations of the support device 1 according to the second example embodiment are similar to those in the first example embodiment. The support device 1 according to the second example embodiment has a function of, when acquiring a design image of a target product, estimating line-of-sight information and opinion information (comment) of a target person with respect to the design of the target product using the design image and the estimation model 23. Similarly to the first example embodiment, since the estimated line-of-sight information and opinion information are information estimated to be obtained through a test such as a central location test, the support device 1 according to the second example embodiment is also advantageous in that information estimated to be obtained through a test such as a central location test can be provided even though the test such as a central location test is not actually conducted.

As a result, the support device 1 according to the second example embodiment can suitably support creation of a product design.

### Third Example Embodiment

Hereinafter, a third example embodiment of the present invention will be described. In the description of the third example embodiment, the same reference signs will be given to components having the same terms as those of the product design generation support device 1 according to the first or second example embodiment, and the redundant description of the common components will be omitted.

The product design generation support device (support device) 1 according to the third example embodiment has a configuration to be described below, and the other configurations are similar to those of the support device 1 according to the first or second example embodiment.

The support device 1 according to the third example embodiment has a configuration for estimating and outputting line-of-sight information and opinion information for a target person more restricted than that in the first or second example embodiment. That is, the target person in the first or second example embodiment may be, for example, a monitor in a central location test, whereas the target person in the third example embodiment is a specified person, such as a person who is in his/her twenties or a person who likes beer, among monitors in a central location test. In the third example embodiment, target person attribute information as information used for specifying such a target person is transmitted, for example, from the terminal device 3 to the support device 1.

In the third example embodiment, the acquisition unit 11 acquires target person attribute information in addition to the design image of the target product. The target person attribute information is information used to specify a target person as described above, and an example of the target person attribute information includes information indicating a group of customers to whom the target product is desired to be mainly sold (in other words, a target group). Note that the target person in the third example embodiment is not limited to the target group, and may be a person having an attribute for which a test is desired to be conducted, for example, a person who is in his/her twenties or a person who likes beer. The acquisition unit 11 acquires attribute information (that is, target person attribute information) for specifying such a person to be tested. Specific examples of the target person attribute information include age, lifestyle information (e.g., information about meals such as the number of meals per day and meal times, an exercise amount per week, sleeping hours, a wake-up time, a bedtime, and a commuting time), preference information, and hobby.

The estimation unit 12 estimates line-of-sight information and opinion information of the target person specified according to the target person attribute information based on the acquired design image of the target product and the acquired target person attribute information with the estimation model 22 or the estimation model 23.

The output unit 13 outputs the estimated line-of-sight information and the estimated opinion information for the specified target person.

Similarly to the support device 1 according to the first or second example embodiment, the support device 1 according to the third example embodiment has a configuration capable of estimating and outputting line-of-sight information and opinion information of a target person with respect to a design of a target product, and thus has the same effect as the support device 1 according to the first or second example embodiment.

In addition, since the support device 1 according to the third example embodiment can output the estimated line-of-sight information and the estimated opinion information for the restricted target person, for example, in a case where the target group of the target product is determined, the estimated line-of-sight information and the estimated opinion information narrowed to the target group can be output by acquiring target person attribute information indicating the target group. That is, the support device 1 according to the third example embodiment can provide more effective information in creating a product design (package design) for which a target group is determined.

### Fourth Example Embodiment

Hereinafter, a fourth example embodiment of the present invention will be described. In the description of the fourth example embodiment, the same reference signs will be given to components having the same terms as those of the product design generation support device 1 according to any one of the first to third example embodiments, and the redundant description of the common components will be omitted.

The product design generation support device (support device) 1 according to the fourth example embodiment further outputs a reason for estimation of estimated opinion information, as compared with the support device 1 according to any one of the first to third example embodiments. That is, in the fourth example embodiment, the estimation unit 12 estimates line-of-sight information and opinion information, and further estimates a reason for the estimation of the estimated opinion information based on the line-of-sight information. The reason for the estimation of the estimated opinion information is a reason (basis) for estimating the opinion indicated as the opinion information. For example, it is assumed that the result of estimating line-of-sight information and opinion information by the estimation unit 12 is as follows.

<Estimation Result>
line-of-sight information: The viewing time of the group of people who like fruits is 15 seconds, which is longer than the average viewing time.
Opinion information: 43% of the group of people who like fruits has an intention to purchase the target product, and this purchase intention is significantly higher than the average purchase intention.

In the case of such an estimation result, the estimation unit 12 outputs, for example, a reason for estimation as follows.

<Reason for Estimation>

It is estimated that the reason why the group of people who like fruits has a high purchase intention is that they like the design of the product based on the fact that the viewing time is longer than the average viewing time.

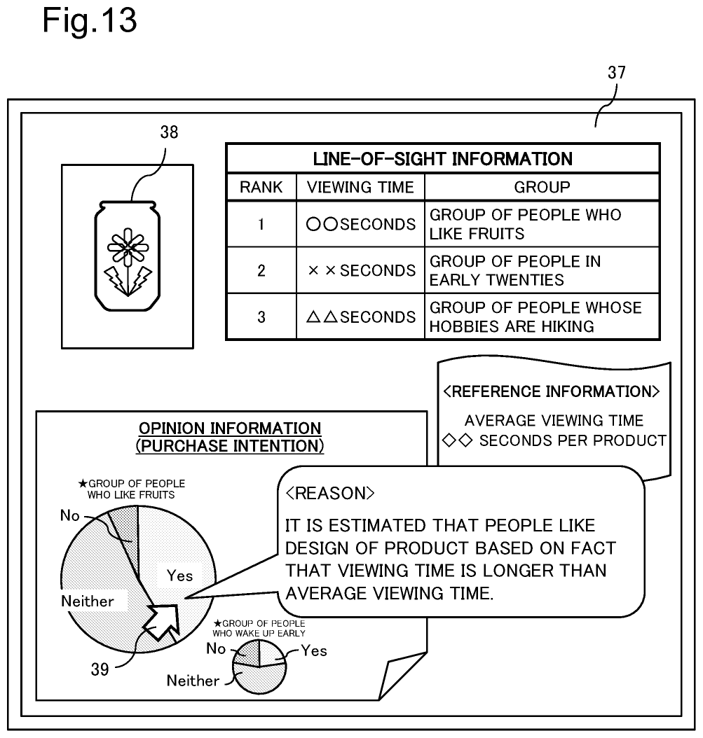

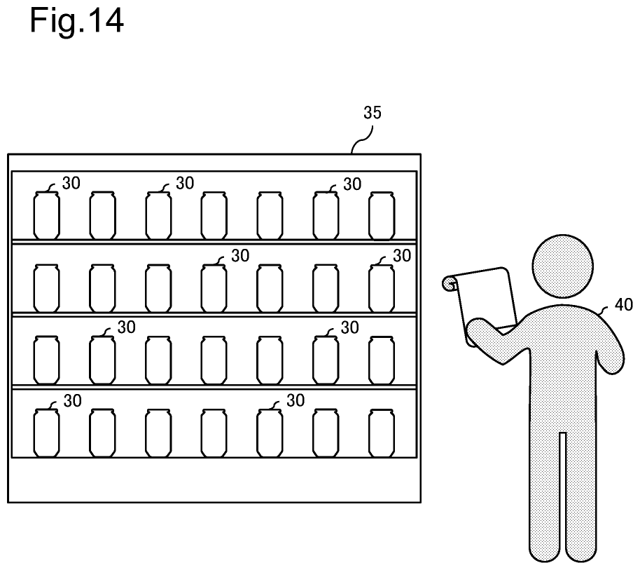

The output unit 13 outputs the estimated line-of-sight information, the estimated opinion information, and the reason for estimation estimated by the estimation unit 12. Similarly to the above-described example embodiments, the estimated line-of-sight information, the estimated opinion information, the reason for estimation output by the output unit 13 as described above are transmitted, for example, to the terminal device 3, and are displayed on the display device according to a display control operation of the terminal device 3. FIG. 13 is a diagram illustrating an example in which estimated line-of-sight information, estimated opinion information, and a reason for estimation are displayed on the display device. In the example of FIG. 13, similarly to the example of FIG. 7 described above, the estimated line-of-sight information, the estimated opinion information, and the reference information are displayed on the screen 37 of the display device together with the design image 38 of the target product. Furthermore, in an area where the opinion information is displayed, the reason for estimating the opinion designated by a pointer 39 is popped up.

The other configurations of the support device 1 according to the fourth example embodiment are similar to those of the support device 1 according to the first, second, or third example embodiment.

As described above, the support device 1 according to the fourth example embodiment further outputs a reason for estimation, as compared with the support device 1 according to any one of the first to third example embodiments. The support device 1 according to the fourth example embodiment can achieve the same effects as those of the first to third example embodiments, and also has an effect of easily interpreting the estimated line-of-sight information and the estimated opinion information using the reason for estimation. Since the reason for estimation enables easy interpretation of the estimated line-of-sight information and the estimated opinion information, the reason for estimation is information that makes it possible to more effectively use the estimated line-of-sight information and the estimated opinion information.

### Fifth Example Embodiment

Hereinafter, a fifth example embodiment of the present invention will be described. In the description of the fifth example embodiment, the same reference signs will be given to components having the same terms as those of the product design generation support device 1 according to any one of the first to fourth example embodiments, and the redundant description of the common components will be omitted.

Meanwhile, as illustrated in FIG. 14, a plurality of types of products 30 may be displayed on a shelf 35 for sales. Assuming such a sales aspect, the product design generation support device (support device) 1 according to the fifth example embodiment estimates and outputs line-of-sight information and opinion information of a target person with respect to a design of a target product.

That is, in the fifth example embodiment, the product information learned to generate the estimation model 22 or the estimation model 23 (hereinafter also referred to as estimation model 22 or 23) includes, for example, display position information of a shelf 35 as illustrated in FIG. 14 at a test site or the like for a central location test. The display position information is shelf position information expressed as, for example, the right end of the uppermost row or the center of the third row from the top.

In the fifth example embodiment, the input to the estimation model 22 or 23 includes, as the target product attribute information, display position information of a shelf 35 on which the target product is assumed to be arranged, in addition to the design image of the target product. In addition, line-of-sight information and opinion information of the target person estimated using the shelf position information of the target product with respect to the design of the target product are output from the estimation model 22 or 23.

In the fifth example embodiment, a design image of a target product and a display position (shelf position information) of the target product on the shelf 35, which is target product attribute information, are transmitted, for example, from the terminal device 3 to the support device 1. The acquisition unit 11 of the support device 1 acquires the design image of the target product and the target product attribute information. The estimation unit 12 estimates line-of-sight information and opinion information of a target person with respect to the design of the target product using the acquired design image of the target product and the acquired target product attribute information with the estimation model 22 or 23. The estimated line-of-sight information includes, for example, an estimated viewing time, such as information indicating that the viewing time for which the monitor looks at the target product placed at the right end of the uppermost row is estimated to be 8 seconds. The estimated line-of-sight information includes at least one of an estimated viewing time, an estimated number of viewing times, and an estimated viewing rate. Furthermore, the estimated opinion information includes purchase intention information such as information indicating that 30% of the monitors 40 who have looked at a design of a target product placed at the right end of the uppermost row are estimated to answer that they want to purchase the target product, or text comment information such as “the color is plain and unobtrusive”.

In addition, in a case where the target person is restricted as in the third example embodiment, the acquisition unit 11 acquires a design image of a target product, target product attribute information (shelf position information), and target person attribute information restricting the target person. The estimation unit 12 estimates line-of-sight information and opinion information of the restricted target person with respect to the design of the target product using the design image of the target product, the target product attribute information (shelf position information), and the target person attribute information, with the estimation model 22 or 23.

The other configurations of the support device 1 according to the fifth example embodiment are similar to those in the first to fourth example embodiments.

The support device 1 according to the fifth example embodiment has the same effects as those of the first to fourth example embodiments. In addition, since the support device 1 according to the fifth example embodiment has the above-described configuration, it is possible to output line-of-sight information and opinion information of the target person in consideration of the aspect in which the target product is sold. Such information is also very effective in creating a design of a target product.

### Sixth Example Embodiment

Hereinafter, a sixth example embodiment of the present invention will be described. In the description of the sixth example embodiment, the same reference signs will be given to components having the same terms as those of the product design generation support device 1 according to any one of the first to fifth example embodiments, and the redundant description of the common components will be omitted.

In the product design generation support device (support device) 1 according to the sixth example embodiment, the acquisition unit 11 acquires a plurality of design images representing different designs. The plurality of design images may be images (candidate images) representing different design candidates for the same target product (e.g., the same can beverage), or may be images representing different designs for different target products (e.g., can beverages having different tastes), respectively.

The estimation unit 12 estimates line-of-sight information and opinion information of a target person, for each of the plurality of design images, using the estimation model 22 or 23. The estimation unit 12 also ranks the designs in the plurality of design images based on one or both of the estimated line-of-sight information and the estimated opinion information. For example, it is assumed that line-of-sight information and opinion information (e.g., purchase intention information) with respect to design images representing 10 types of designs, i.e., designs A to J, respectively, are estimated by the estimation unit 12. Based on the viewing rates of the estimated line-of-sight information, the first to tenth ranks are assigned to the designs A to J in descending order of numerical values of the viewing rates. In addition, the first to tenth ranks are assigned to the designs A to J in descending order of numerical values (values representing percentages) each indicating an estimated purchase intention, such as information indicating that 55% of the monitors 40 are estimated to answer that they want to purchase the target product. Furthermore, in a case where the designs are ranked using both the estimated line-of-sight information and the estimated purchase intention, the viewing rate for each of, for example, the designs A to J is converted into a viewing score according to a viewing rate conversion method given in advance. In addition, the numerical value representing a purchase intention for each of the designs A to J is converted into a purchase intention score based on a purchase intention conversion method given in advance. Then, the first rank to the tenth rank are assigned to the designs A to J, for example, in descending order of total scores each obtained by summing the viewing score and the purchase intention score.

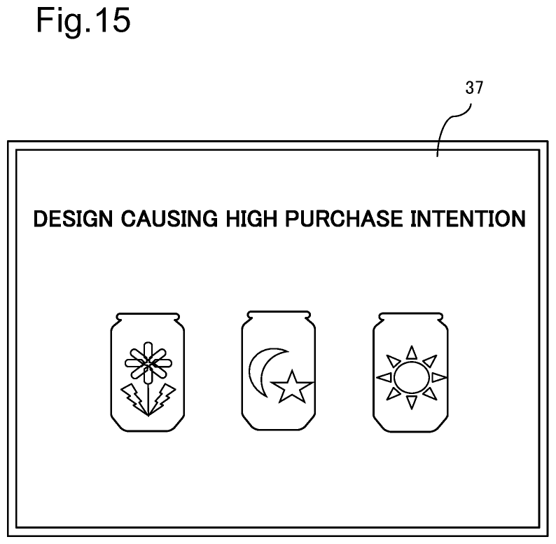

The output unit 13 outputs estimated line-of-sight information and estimated opinion information of target persons with respect to the respective designs shown in the plurality of design images acquired by the acquisition unit 11, and outputs rank information indicating ranks of designs based on one or both of the estimated line-of-sight information and the estimated opinion information. That is, the output unit 13 may output rank information including one or both of the ranks of the designs based on the estimated line-of-sight information and the ranks of the designs based on the estimated line-of-sight information, or may output the ranks of the designs based on both the estimated line-of-sight information and the estimated opinion information as rank information. FIG. 15 illustrates a display example of the display device according to a display control operation of the terminal device 3 that has also received the rank information of the designs. In the example of FIG. 15, a design of a target product is displayed together with the rank information thereof.

The support device 1 according to the sixth example embodiment has the same effects as those of the first to fifth example embodiments. In addition, since the support device 1 according to the sixth example embodiment has the above-described configuration, rank information with respect to a plurality of designs to be compared with each other can be provided based on information that needs to be focused on in creating a design of a product, such as line-of-sight information and opinion information of target persons.

### Other Example Embodiments

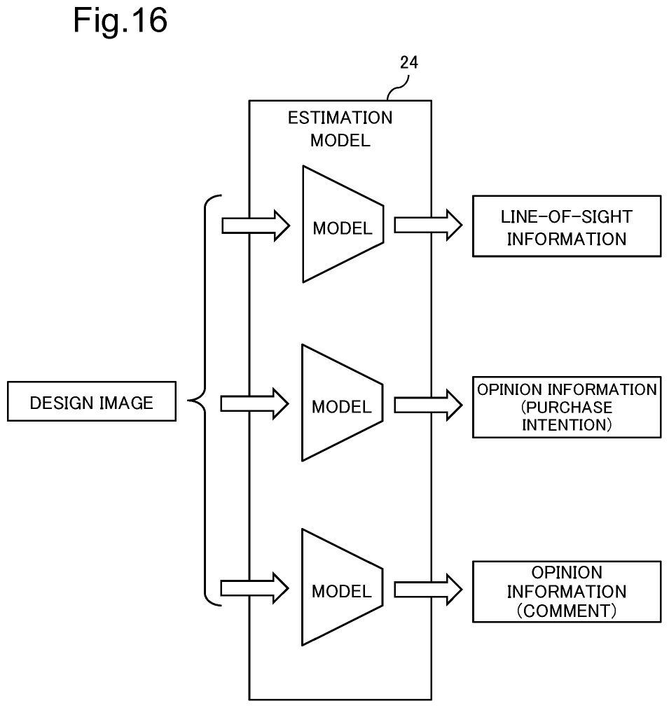

Note that the present invention is not limited to the first to sixth example embodiments, and various embodiments can be adopted. For example, in the first to sixth example embodiments, the estimation unit 12 estimates one of purchase intention information and comment information as opinion information. Alternatively, for example, the estimation unit 12 may estimate opinion information including both purchase intention information and comment information by using an estimation model 24 as illustrated in FIG. 16. The estimation model 24 includes three types of models that outputs line-of-sight information, and a purchase intention and a comment, which are opinion information, separately from each other, when a design image is input thereto.

Furthermore, although the support device 1 has been described in each of the first to sixth example embodiments with a package design exemplified as a product design, the support device 1 according to any one of the first to sixth example embodiments is not limited to the package design, and the product design may be, for example, a design of an article accommodated in a package or a design of a product itself without a package.

Furthermore, in each of the first to sixth example embodiments, it is exemplified that the line-of-sight information and the opinion information used for generating the estimation model 22 or 23 are acquired through a central location test. Alternatively, the line-of-sight information and the opinion information may be acquired, for example, through a questionnaire survey on the street. In this case as well, line-of-sight information of a person can be acquired from the captured image (or the captured moving image) obtained by imaging the person who is answering the questionnaire using an imaging device in the same manner as described above. Furthermore, in each of the first to sixth example embodiments, line-of-sight information obtained in a case where a person is directly looking at a product 30, and opinion information obtained in a case where a person has directly looked at a product 30 are used. Alternatively, for example, line-of-sight information obtained in a case where a target person is looking at a product 30 placed in an advertisement on a newspaper, a magazine, a television, or a website, or an advertisement in a public transportation facility, or opinion information obtained in a case where a target person has looked at a product 30 placed in such an advertisement. Furthermore, the estimation model 22 or 23 may be generated using the line-of-sight information and the opinion information obtained in a case where the product 30 has been directly looked at, and the line-of-sight information and the opinion information obtained in a case where the product 30 has been looked at through an advertisement or the like. As described above, the acquisition of the line-of-sight information and the opinion information used for generating the estimation model 22 or 23 is not limited to the central location test.

Further, the support device 1 according to any one of the first to sixth example embodiments may construct a product design generation support system, for example, together with the terminal device 3 to which the support device is connected.

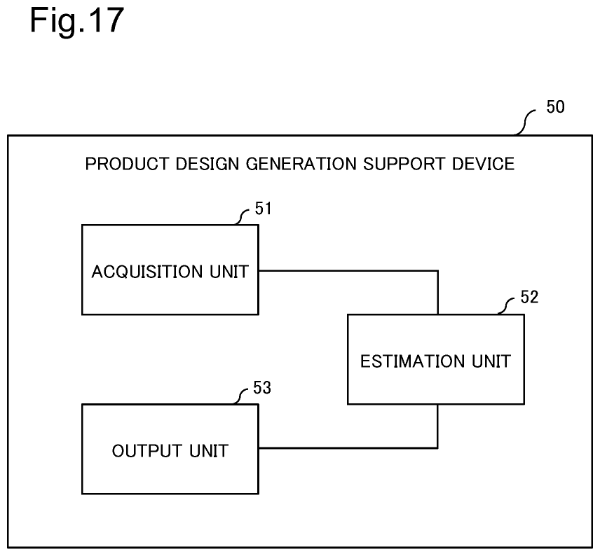

FIG. 17 is a block diagram illustrating a minimum configuration of the product design generation support device. The product design generation support device 50 includes an acquisition unit 51, an estimation unit 52, and an output unit 53. The product design generation support device 50 is, for example, a computer device in which the acquisition unit 51, the estimation unit 52, and the output unit 53 are implemented as in the first to sixth example embodiments.

The acquisition unit 51 acquires a design image relating to a design of a target product. The estimation unit 52 estimates line-of-sight information and opinion information of a target person with respect to the design of the target product, using the design image and an estimation model. The estimation model is a model obtained by changing the person and the product in various ways while learning relations of product information for learning including the design image of the product and attribute information for learning of the person with line-of-sight information for learning of the person with respect to the design of the product and opinion information for learning of the person with respect to the design of the product.

The output unit 53 outputs the line-of-sight information and the opinion information estimated by the estimation unit 52.

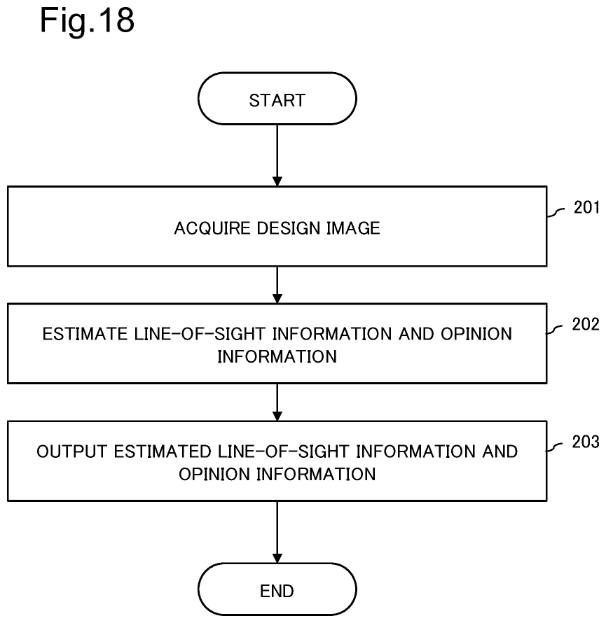

FIG. 18 is a flowchart illustrating an example of an operation of the product design generation support device 50. For example, the acquisition unit 51 acquires a design image related to a design of a target product (step 201). Thereafter, the estimation unit 52 estimates line-of-sight information and opinion information of a target person with respect to the design of the target product using the design image and an estimation model (step 202). Then, the output unit 53 outputs the estimated line-of-sight information and opinion information (step 203).

With the configuration as described above, the product design generation support device 50 is advantageous in that it is possible to efficiently generate and provide information effective for creating and determining a design of a product.

Some or all of the above-described example embodiments may be described as in the following supplementary notes, but are not limited to the following supplementary notes.

(Supplementary Note 1)

A product design generation support device including:
an acquisition means configured to acquire a design image related to a design of a target product;
an estimation means configured to estimate line-of-sight information and opinion information of a target person with respect to the design of the target product using the design image and an estimation model; and
an output means configured to output the line-of-sight information and the opinion information,
in which the estimation model is a model obtained by learning relations of product information for learning including a design image of a product and attribute information for learning of the person with line-of-sight information for learning of the person with respect to the design of the product and opinion information for learning of the person with respect to the design of the product.

(Supplementary Note 2)

The product design generation support device according to supplementary note 1, in which the estimation means further estimates a reason for the estimation of the opinion information based on the line-of-sight information, and the output means further outputs the reason for the estimation.

(Supplementary Note 3)

The product design generation support device according to supplementary note 1 or 2, in which the opinion information includes an opinion of the target person on whether to purchase the target product.

(Supplementary Note 4)

The product design generation support device according to any one of supplementary notes 1 to 3, in which the opinion information includes a text expressing an opinion of the target person with respect to the design of the target product.

(Supplementary Note 5)

The product design generation support device according to any one of supplementary notes 1 to 4, in which the line-of-sight information includes at least one of a viewing time for which the target person looks at the target product, the number of viewing times that the target person looks at the target product, and a viewing rate that is a ratio of the time for which the target person looks at the target product or the number of times that the target person looks at the target product to a time for which the target person looks at a plurality of products including the target product or the number of times that the target person looks at the plurality of products including the target product.

(Supplementary Note 6)

The product design generation support device according to any one of supplementary notes 1 to 5, in which the acquisition means further acquires target product attribute information for the target product and target person attribute information for the target person, the estimation means estimates the opinion information with respect to the design of the target product using the design image, the target person attribute information, the target product attribute information, and the estimation model, and the output means outputs the opinion information.

(Supplementary Note 7)

The product design generation support device according to supplementary note 6, in which the target product is a product displayed on a shelf, and the target product attribute information includes a position at which the target product is displayed on the shelf.

(Supplementary Note 8)

The product design generation support device according to supplementary note 6 or 7, in which the target person attribute information is an attribute of the target person having a specific attribute, and the estimation means estimates the opinion information and the line-of-sight information of the target person having the specific attribute with respect to the design of the target product.

(Supplementary Note 9)

The product design generation support device according to any one of supplementary notes 1 to 8, in which the acquisition means acquires a plurality of design images in which different designs are shown, the estimation means estimates the opinion information and the line-of-sight information with respect to the respective designs shown in the plurality of design images, and the output means further outputs ranks of the designs based on at least one of the opinion information and the line-of-sight information.

(Supplementary Note 10)

A product design generation support system including:
an acquisition means configured to acquire a design image related to a design of a target product;
an estimation means configured to estimate line-of-sight information and opinion information of a target person with respect to the design of the target product using the design image and an estimation model; and
an output means configured to output the line-of-sight information and the opinion information,
in which the estimation model is a model obtained by learning relations of product information for learning including the design image of the product and attribute information for learning of the person with line-of-sight information for learning of the person with respect to the design of the product and opinion information for learning of the person with respect to the design of the product.

(Supplementary Note 11)

A product design generation support method performed by a computer, the product design generation support method including:
acquiring a design image related to a design of a target product;
estimating line-of-sight information and opinion information of a target person with respect to the design of the target product using the design image and an estimation model; and
outputting the line-of-sight information and the opinion information,
in which the estimation model is a model obtained by learning relations of product information for learning including the design image of the product and attribute information for learning of the person with line-of-sight information for learning of the person with respect to the design of the product and opinion information for learning of the person with respect to the design of the product.

(Supplementary Note 12)

A program storage medium storing a computer program that causes a computer to execute:
acquiring a design image related to a design of a target product;
estimating line-of-sight information and opinion information of a target person with respect to the design of the target product using the design image and an estimation model; and
outputting the line-of-sight information and the opinion information,
in which the estimation model is a model obtained by learning relations of product information for learning including a design image of a product and attribute information for learning of the person with line-of-sight information for learning of the person with respect to the design of the product and opinion information for learning of the person with respect to the design of the product.

The present invention has been described above using the above-described example embodiments as exemplary embodiments. However, the present invention is not limited to the above-described example embodiments. That is, various aspects of the present invention that can be understood by those of ordinary skill in the art may be applied within the scope of the present invention.

### REFERENCE SIGNS LIST

1, 50 Product design generation support device
11, 51 Acquisition unit
12, 52 Estimation unit
13, 53 Output unit
22, 23, 24 Estimation model
30 Product
35 Shelf

What is claimed is:

1. A product design generation support device comprising:
a memory configured to store instructions; and
at least one processor configured to execute the instructions to:
acquire a design image related to a design of a target product;
estimate line-of-sight information and opinion information of a target person with respect to the design of the target product using the design image and an estimation model; and
output the line-of-sight information and the opinion information,
wherein the estimation model is a model obtained by learning relations of product information and attribute information with line-of-sight information and opinion information, the product information is information for learning including a design image of a product, the attribute information is information for learning of the person, the line-of-sight information is information for learning of the person with respect to the design of the product t, the opinion information is information for learning of the person with respect to the design of the product.

2. The product design generation support device according to claim 1, wherein the at least one processor is further configured to estimate a reason for the estimation of the opinion information based on the line-of-sight information, and
output the reason for the estimation.

3. The product design generation support device according to claim 1, wherein the opinion information includes an opinion of the target person on whether to purchase the target product.

4. The product design generation support device according to claim 1, wherein the opinion information includes a text expressing an opinion of the target person with respect to the design of the target product.

5. The product design generation support device according to claim 1, wherein the line-of-sight information includes at least one of a viewing time for which the target person looks at the target product, the number of viewing times that the target person looks at the target product, and a viewing rate that is a ratio of the time for which the target person looks at the target product or the number of times that the target person looks at the target product to a time for which the target person looks at a plurality of products including the target product or the number of times that the target person looks at the plurality of products including the target product.

6. The product design generation support device according to claim 1, wherein the at least one processor is further configured to acquire target product attribute information for the target product and target person attribute information for the target person,
estimate the opinion information with respect to the design of the target product using the design image, the target person attribute information, the target product attribute information, and the estimation model, and
output the opinion information.

7. The product design generation support device according to claim 6, wherein the target product is a product displayed on a shelf, and
the target product attribute information includes a position at which the target product is displayed on the shelf.

8. The product design generation support device according to claim 6, wherein the target person attribute information is an attribute of the target person having a specific attribute, and
the at least one processor is configured to estimate the opinion information and the line-of-sight information of the target person having the specific attribute with respect to the design of the target product.

9. The product design generation support device according to claim 1, wherein the at least one processor is configured further to acquire a plurality of design images in which different designs are shown,
estimate the opinion information and the line-of-sight information with respect to the respective designs shown in the plurality of design images, and
output ranks of the designs based on at least one of the opinion information and the line-of-sight information.

10. (canceled)

11. A product design generation support method performed by a computer, the product design generation support method comprising:
acquiring a design image related to a design of a target product;
estimating line-of-sight information and opinion information of a target person with respect to the design of the target product using the design image and an estimation model; and
outputting the line-of-sight information and the opinion information,
wherein the estimation model is a model obtained by learning relations of product information and attribute information with line-of-sight information and opinion information, the product information is information for learning including a design image of a product, the attribute information is information for learning of the person, the line-of-sight information is information for learning of the person with respect to the design of the product t, the opinion information is information for learning of the person with respect to the design of the product.

12. A non-transitory computer readable medium storing a computer program that causes a computer to execute:
acquiring a design image related to a design of a target product;
estimating line-of-sight information and opinion information of a target person with respect to the design of the target product using the design image and an estimation model; and
outputting the line-of-sight information and the opinion information,
wherein the estimation model is a model obtained by learning relations of product information and attribute information with line-of-sight information and opinion information, the product information is information for learning including a design image of a product the attribute information is information for learning of the person the line-of-sight information is information for learning of the person with respect to the design of the product t the opinion information is information for learning of the person with respect to the design of the product.
